(19) United States
(12) Patent Application Publication
(10) Pub. No.: US 2026/0277509 A1
(43) Pub. Date: Sep. 17, 2026

(54) IMAGE FORMING SYSTEM AND CONTROL METHOD FOR IMAGE FORMING SYSTEM

(71) Applicant: SEIKO EPSON CORPORATION, TOKYO (JP)

(72) Inventor: Satoshi AIBA, SHIOJIRI-SHI (JP)

(21) Appl. No.: 19/564,771

(22) Filed: Mar. 12, 2026

(30) Foreign Application Priority Data
Mar. 12, 2025 (JP) 2025-039106

(51) Int. Cl. G06F 3/12

(52) U.S. Cl. CPC G06F 3/1221; G06F 3/1229; G06F 3/1239; G06F 3/1255

(57) ABSTRACT

An image forming system includes a print head, a medium transport section, a display section that displays information, an input section that receives an input, and a control section, wherein the control section calculates a printable number of sheets of a medium based on power supply information including information that indicates a capacitance of a power supply, displays, on the display section, information that indicates printing cannot be completed when the printable number of sheets is smaller than an input print sheet number, and displays, on the display section, information that indicates printing is possible when the printable number of sheets is equal to or larger than the print sheet number.

The present application is based on, and claims priority from JP Application Serial Number 2025-039106, filed Mar. 12, 2025, the disclosure of which is hereby incorporated by reference herein in its entirety.

### BACKGROUND

### 1. Technical Field

The present disclosure relates to an image forming system and a control method for the image forming system.

### 2. Related Art

An image forming system disclosed in JP-A-2023-30667 includes an image forming device. The image forming device has an operation mode for when connecting to a commercial power supply and an operation mode for when connecting to an individual power supply. The operation mode for when connecting to a commercial power supply is a mode in which the image forming device is operated by the electric power supplied from a commercial power supply. The operation mode for when connecting to an individual power supply is a mode in which the image forming device is operated by power supplied from an individual power supply. The individual power supply is, for example, an uninterruptible power supply or a portable power supply.

The capacitance of an individual power supply such as an uninterruptible power supply or a portable power supply decreases with use. Therefore, sometimes the job instructed by the user may not be completed

### SUMMARY

An image forming system that solves the above problem is an image forming system that operates by power supplied from power supply and that includes a print head configured to print on a medium; a medium transport section that transports the medium toward the print head; a display section configured to display information related to the printing; an input section that receives input from a user; and a control section configured to control the display section; wherein the control section calculates a printable number of sheets of the medium that are printable by the print head based on power supply information, which is information of the power supply and which includes at least information indicating capacitance of the power supply, displays, on the display section, information indicating that printing cannot be completed when the printable number of sheets is smaller than a print sheet number input by the user, and displays, on the display section, information indicating that printing is possible when the printable number of sheets is the same as the print sheet number or when the printable number of sheets is larger than the print sheet number.

A control method of an image forming system operated by power supplied from a power supply, the image forming system including a print head that performs printing on a medium, a display section that is configured to display information related to printing, and an input section that receives an input from a user, the control method including acquiring power supply information including information that indicate a capacitance of the power supply; calculating, based on the power supply information, a printable number of sheets, which is a number of sheets of the medium on which printing by the print head is possible; displaying, on the display section information indicating that printing cannot be completed when the printable number of sheets is smaller than the print sheet number input by the user; and displaying, on the display section, information indicating that printing is possible when the printable number of sheets is the same as the print sheet number or when the printable number of sheets is larger than the print sheet number.

### BRIEF DESCRIPTION OF THE DRAWINGS

FIG. 1 is a perspective view illustrating an example of an image forming system.

FIG. 2 is a schematic configuration diagram of the image forming system.

FIG. 3 is a flowchart illustrating a print control according to the first embodiment.

FIG. 4 is a diagram illustrating an example of a power supply information input screen.

FIG. 5 is a diagram illustrating an example of information indicating that printing cannot be completed.

FIG. 6 is a flowchart illustrating update control.

FIG. 7 is a flowchart illustrating a print control according to the second embodiment.

FIG. 8 is a diagram illustrating an example of a display screen.

FIG. 9 is a flowchart illustrating a print control according to the third embodiment.

FIG. 10 is a diagram illustrating an example of an option selection screen.

### DESCRIPTION OF EMBODIMENTS

### First Embodiment

A first embodiment of an image forming system will be described.

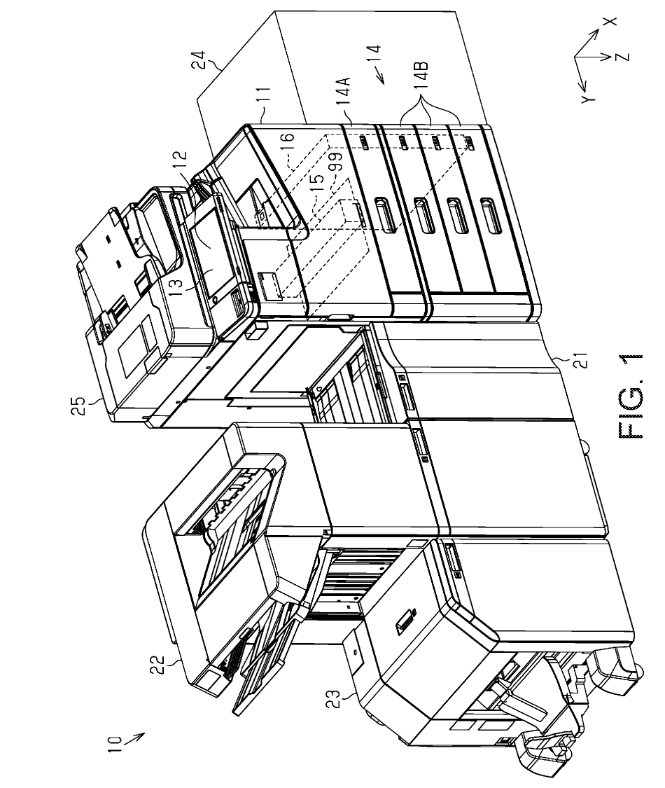

As illustrated in FIG. 1, an image forming system 10 includes an image forming device 11, an intermediate device 21, a post-process device 22, and a center folding device 23. The image forming system 10 is placed on a horizontal plane. The direction of gravity is indicated by a Z-axis, and the directions along the horizontal plane are indicated by a X-axis and a Y-axis. The X-axis, the Y-axis, and the Z-axis are orthogonal to each other. In the following description, a direction parallel to the X-axis is also referred to as a width direction X, a direction parallel to the Y-axis is also referred to as a transport direction Y, and a direction parallel to the Z-axis is also referred to as a vertical direction Z.

The image forming device 11 is, for example, an ink jet type printer that forms an image by ejecting ink, which is an example of a liquid, onto a medium 99. The image is formed by the liquid that adheres to the medium 99. The image includes at least one of a photograph, a pattern, a character, a symbol, a mark, a line, and a table.

The image forming device 11 includes a display section 12 configured to display information related to printing.

The image forming device 11 includes an input section 13. The input section 13 receives input from a user. The input section 13 is, for example, a touch panel. The input section 13 may be a physical button. When the input section 13 is a touch panel, the input section 13 is provided integrally with the display section 12.

The image forming device 11 includes a medium accommodating section 14. The medium accommodating section 14 is configured to accommodate the medium 99 in a stacked state. The medium accommodating section 14 includes a built-in cassette 14A. The medium accommodating section 14 may include at least one additional cassette 14B. The additional cassette 14B is, for example, a cassette that is added as an option.

The image forming device 11 includes a print head 15 that performs printing on the medium 99. The print head 15 performs, for example, printing on the medium 99 by ejecting liquid from the nozzles. An image is formed on the medium 99 by printing on the medium 99 using the print head 15. The print head 15 forms an image on the medium 99 fed one sheet at a time from the medium accommodating section 14. The print head 15 of the present embodiment is a line type provided over the width direction X of the medium 99. The print head 15 may be a serial type that forms an image while moving in the width direction X of the medium 99.

The image forming device 11 includes a medium transport section 16. The medium transport section 16 includes, for example, a guide member that guides the medium 99, a roller, and a motor that rotates the roller.

The medium transport section 16 transports, for example, the medium 99 accommodated in the medium accommodating section 14 toward the print head 15. The medium transport section 16 may include a first transport path that transports the medium 99 from the built-in cassette 14A to the print head 15, and a second transport path that transports the medium 99 from the additional cassette 14B to the first transport path. A direction in which the medium 99 is transported from the medium transport section 16 toward the print head 15 is a transport direction Y.

The image forming device 11 is configured to perform single-sided image formation in which an image is formed on only one surface of the medium 99, and double-sided image formation in which an image is formed on both surfaces of the medium 99. In the case of performing single-sided image formation, the image forming device 11 forms an image on the front side of the medium 99 and then sends the medium 99 to the intermediate device 21. In the case of performing double-sided image formation, the image forming device 11 forms an image on the front surface of the medium 99, then reverses the medium 99 and returns the medium 99 to the print head 15, and forms an image on the back surface of the medium 99. The image forming device 11 sends the medium 99 on which images are formed on both sides to the intermediate device 21.

The intermediate device 21 is adjacent to the image forming device 11 in the transport direction Y. The intermediate device 21 sends the medium 99 on which an image is formed on one side or both sides to the post-process device 22. In a case where the medium 99 on which an image is formed is subjected to a center folding process of the medium 99, the post-process device 22 sends the medium 99 to the center folding device 23. The center folding device 23 may perform a saddle stitching process on the medium 99 to stitch the center of the medium 99 with a staple. In this manner, the center folding device 23 performs processes such as a center folding process or a saddle stitching process on the medium 99 on which printing was performed, that is, the medium 99 on which an image was formed.

The post-process device 22 is adjacent to the intermediate device 21 in the transport direction Y. The post-process device 22 performs processes on the medium 99 on which printing was performed, that is, the medium 99 on which an image was formed. The processes performed on the medium 99 by the post-process device 22 are referred to as post-processing. The post-processing includes at least one of an alignment process, a staple process, a punch process, and a shift process. The alignment process is a process of aligning the sides of the medium 99 in a state where plural sheets of the medium 99 are bundled. The staple process is a process of binding plural sheets of the medium 99 with staples. The punch process is a process of punching a hole in one or plural sheets of the medium 99. The shift process discharges the medium 99 in sets while shifting the position of the medium 99 for each set. The post-process device 22 is an example of a processing section.

The post-process device 22 is not limited to a floor standing type. Instead of the floor standing type post-process device 22, a functional unit for post-process may be incorporated into the image forming device 11. The floor standing type post-process device 22 is also called a floor finisher. The post-process function built into the image forming device 11 is also called an inner finisher.

The image forming system 10 may include a large capacity sheet feeding device 24. The large capacity sheet feeding device 24 is used in combination with the image forming device 11. The large capacity sheet feeding device 24 is adjacent to the image forming device 11 in the transport direction Y. The large capacity sheet feeding device 24 is provided on the opposite side of the image forming device 11 from the intermediate device 21. The large capacity sheet feeding device 24 accommodates one or more sheets of the medium 99. The maximum sheet accommodation number of the medium 99 that can be accommodated in the large capacity sheet feeding device 24 is larger than the maximum sheet accommodation number of the medium 99 that can be accommodated in the built-in cassette 14A. The large capacity sheet feeding device 24 supplies the accommodated medium 99 to the medium transport section 16. The large capacity sheet feeding device 24 is an example of a medium supply device.

The image forming system 10 may include an image reading device 25. The image reading device 25 is adjacent to the image forming device 11 in the vertical direction Z. Specifically, the image reading device 25 is provided in an upper portion of the image forming device 11. The image reading device 25 reads a document as an image. The image reading device 25 generates read data that indicates an image read from a document.

The image reading device 25 may be configured to read one side of the document or may be configured to read both sides of the document. The image reading device 25 may be configured to read a document in full color or may be configured to read a document in grayscale.

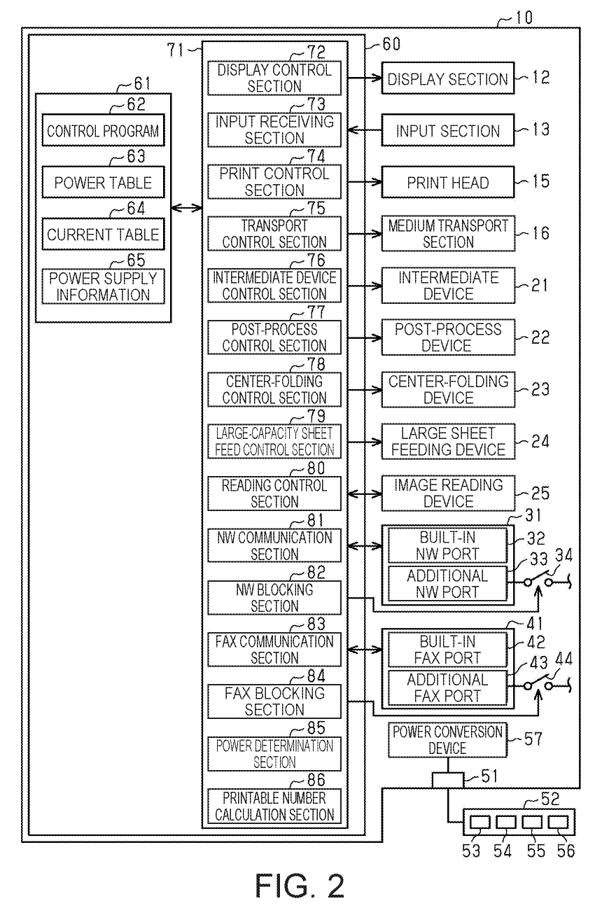

As illustrated in FIG. 2, the image forming system 10 may include a network port 31. A network cable is connected to the network port 31. By this, the image forming system 10 is connected to the external device via the communication network. The external device is, for example, a computer that transmits an instruction to the image forming system 10. The network port 31 includes a built-in network port 32. The network port 31 may include an additional network port 33. The additional network port 33 is, for example, a network port added as an option.

The image forming system 10 may include a FAX port 41. A telephone line cable is connected to the FAX port 41. This enables the image forming system 10 to perform facsimile communication via the public line. The facsimile communication is an operation that transmits the read data to a designated transmission destination. The transmission destination is, for example, another facsimile device. The FAX port 41 includes a built-in FAX port 42. The FAX port 41 may include an additional FAX port 43. The additional FAX port 43 is, for example, a FAX port that is extended as an option.

The image forming system 10 includes a connection section 51. The connection section 51 is, for example, a plug connected to the power supply 52. When the connection section 51 is connected to the power supply 52, power is supplied from the power supply 52 to the image forming system 10. The image forming system 10 operates with power supplied from a power supply 52. The connection section 51 is configured to be connected to a commercial power supply or a portable power supply such as the power supply 52.

The power supply 52 of the present embodiment is the portable power supply. The power supply 52 includes a rechargeable secondary battery 53 and a DC/AC conversion section 54 that converts DC power output from the secondary battery 53 into AC power and outputs the AC power. The power supply 52 outputs power by discharging of the secondary battery 53. That is, the capacitance of the power supply 52 decreases as the power supply 52 is used. The power supply 52 may include a battery management system 55. The battery management system 55 detects the state of the secondary battery 53. The state of the secondary battery 53 includes a charging rate of the secondary battery 53. The power supply 52 may include a display device 56. The display device 56 56 displays the state of the secondary battery 53. For example, the display device 56 displays the charging rate of the secondary battery 53. The power supply 52 may be an uninterruptible power supply.

The image forming system 10 includes a power conversion device 57. Power is supplied to the power conversion device 57 from the power supply 52 connected to the connection section 51. The power conversion device 57 performs power conversion of the power supplied from the power supply 52. The power conversion device 57 includes an AC/DC conversion section that converts AC power into DC power and outputs the DC power. The power conversion device 57 outputs the converted power to the power supply target. The power supply target includes the display section 12, the input section 13, the print head 15, the medium transport section 16, the intermediate device 21, the post-process device 22, the center folding device 23, the large capacity sheet feeding device 24, the image reading device 25, the network port 31, and the FAX port 41.

The image forming system 10 may include a network port switch 34. The network port switch 34 switches between supplying and shutting off power to the additional network port 33. The network port switch 34 is provided, for example, on a power supply line that supplies power output from the power conversion device 57 to the additional network port 33. When the network port switch 34 is closed, the additional network port 33 and the power conversion device 57 are electrically connected to each other. By this, power is supplied to the additional network port 33. When the network port switch 34 is opened, the additional network port 33 and the power conversion device 57 are electrically insulated from each other. By this, the power to the additional network port 33 is cut off.

The image forming system 10 may include a FAX port switch 44. The FAX port switch 44 switches between supply and interruption of power to the additional FAX port 43. The FAX port switch 44 is provided, for example, on a power supply line that supplies power output from the power conversion device 57 to the additional FAX port 43. When the FAX port switch 44 is closed, the additional FAX port 43 and the power conversion device 57 are electrically connected to each other. By this, power is supplied to the additional FAX port 43. When the FAX port switch 44 is opened, the additional FAX port 43 and the power conversion device 57 are electrically insulated from each other. By this, the power to the additional FAX port 43 is cut off.

The image forming system 10 includes a control section 60. The control section 60 may be configured by one or more processors that execute various processes according to a computer program. The control section 60 may be configured by one or more dedicated hardware circuits, for example, ASICs, that execute at least a part of the various processes. The control section 60 may be configured by a circuit including a combination of a processor and a hardware circuit. The processor includes a CPU and a memory 61 such as a RAM and a ROM. The memory 61 stores program codes or instructions configured to cause the CPU to execute processing. The memory, that is, a computer readable medium, includes any readable medium that can be accessed by a general-purpose or dedicated computer.

The memory 61 stores a control program 62. The control program 62 is a program executed by the control section 60.

The memory 61 stores a power table 63. The power table 63 is a table in which an electric device that operates by consuming power is associated with a power value (W) required for the operation of the electric device. The power value required for the operation of the electric device is a power value required for the electric device to perform one process or a power value required per unit time for the electric device to operate. The electric device includes, for example, the print head 15, the medium transport section 16, the intermediate device 21, the post-process device 22, the center folding device 23, the large capacity sheet feeding device 24, the image reading device 25, the network port 31, and the FAX port 41. The power table 63 may associate each of the print head 15, the medium transport section 16, the intermediate device 21, the post-process device 22, the center folding device 23, the large capacity sheet feeding device 24, the image reading device 25, the network port 31, and the FAX port 41 with a power value required for an operation.

The power value required for the operation of the medium transport section 16 differs depending on whether the function of the additional cassette 14B is enabled or disabled. By this, in the power table 63, different power values may be associated with a case where the function of the additional cassette 14B is enabled and a case where the function of the additional cassette 14B is disabled.

The power value required for the operation of the post-process device 22 is a power value required for the operation of the floor finisher. The power table 63 may include a power value required for the operation of the inner finisher. This allows the power table 63 to be used also in an image forming system including an inner finisher. That is, the power table 63 may be used for general purposes in different types of image forming systems.

The power value required for the operation of the network port 31 differs depending on whether the function of the additional network port 33 is enabled or disabled. By this, in the power table 63, different power values may be associated with a case where the function of the additional network port 33 is enabled and a case where the function of the additional network port 33 is disabled.

The power value required for the operation of the FAX port 41 differs depending on whether the function of the additional FAX port 43 is enabled or disabled. Therefore, the power table 63 may associate different power values with the case where the function of the additional FAX port 43 is enabled and the case where the function of the additional FAX port 43 is disabled.

The power table 63 may associate the electric device with the power value required for the operation of the electric device in correspondence with a plurality of print modes. The print modes may include a mode that performs color printing, a mode for performing monochrome printing, a mode with a different resolution, and a mode with a different size of the medium 99. The power value required for the operation of the electric device is different between color printing and monochrome printing. The power value required for the operation of the electric device also varies depending on the size of the medium 99.

Therefore, when the image forming system 10 has a plurality of print modes, the power table 63 may associate the power value required for the operation of the electric device with the print modes.

The power table 63 may associate the electric device with the power value required for the operation of the electric device in correspondence with each of printing by the copy function and printing by the print function. The copy function is a function that prints an image read by the image reading device 25 on the medium 99. The printing function is a function that performs printing on the medium 99 using image data acquired from a computer via a communication network or image data acquired from a storage medium that is attachable to and detachable from the image forming system 10. The copy function and the print function require different power values for the operation of the electric device. Therefore, the power table 63 may be a table in which the power values required for the operation of the electric device are associated with the copy function and the print function.

The memory 61 may store a current table 64. The current table 64 is a table in which the electric device is associated with a current value (A) required for the operation of the electric device. The current value required for the operation of the electric device is a current value required for the electric device to perform one process or a current value required per unit time for the electric device to operate.

In the current table 64, different current values may be associated with a case where the function of the additional cassette 14B is enabled and a case where the function of the additional cassette 14B is disabled. The current table 64 may include a current value required for the operation of the inner finisher. In the current table 64, different current values may be associated with a case where the function of the additional network port 33 is enabled and a case where the function of the additional network port 33 is disabled. The current table 64 may associate different current values with a case where the function of the additional FAX port 43 is enabled and a case where the function of the additional FAX port 43 is disabled. The current table 64 may be a table in which the electric device and the current value required for the operation of the electric device are associated with each other in correspondence with a plurality of print modes. The current table 64 may associate the electric device with the current value required for the operation of the electric device in correspondence with each of printing by the copy function and printing by the print function.

The memory 61 stores power supply information 65. The power supply information 65 is information on the power supply 52. The information on the power supply 52 includes at least information that indicates the capacitance (Wh) of the power supply 52. The capacitance of the power supply 52 is the remaining capacitance of the power supply 52, that is, the remaining capacitance of the secondary battery 53. The information that indicates the capacitance of the power supply 52 may be information on the capacitance of the power supply 52 itself or information from which the capacitance of the power supply 52 can be calculated. The information that enables calculation of the capacitance of the power supply 52 is, for example, information that indicates the rated capacity of the power supply 52 and information that indicates the charging rate of the power supply 52.

The power supply information 65 may include information that indicates the specification of the power supply 52. The information that indicates the specification of the power supply 52 may include information that indicates the rated capacity of the power supply 52 and information that indicates the maximum output current of the power supply 52.

The control section 60 includes a control unit 71. The control unit 71 is configured by software configured by the computer of the control section 60 that executes the control program 62 and the like, and hardware such as an ASIC.

The control unit 71 includes a display control section 72. The display control section 72 controls the display section 12. That is, the control section 60 controls the display section 12. The display control section 72 updates information displayed on the display section 12. By this, the image forming system 10 provides information to the user through the display section 12.

The control unit 71 includes an input receiving section 73. The input receiving section 73 receives input information input by the user through the input section 13. The input information includes an instruction by the user and the power supply information 65.

The control unit 71 includes a print control section 74. The print control section 74 controls the operation of the print head 15 to control the ejection of ink from the print head 15. For example, the print control section 74 controls the timing of printing, the amount of ink ejected from the print head 15, and the ejection position of the ink.

The print control section 74 may perform print on the medium 99 based on the read data acquired from the image reading device 25. That is, the image forming system 10 may have a copy function. The print control section 74 may perform printing on the medium 99 using image data acquired from a computer via a communication network or image data acquired from a storage medium that is attachable to and detachable from the image forming system 10.

The control unit 71 includes a transport control section 75. The transport control section 75 controls the medium transport section 16 to transport the medium 99 toward the print head 15. For example, the transport control section 75 causes the medium transport section 16 to transport the medium 99 by the operation of a motor that rotates a roller.

The control unit 71 may include an intermediate device control section 76. The intermediate device control section 76 controls the intermediate device 21. The intermediate device control section 76 controls the intermediate device 21 so that the medium 99 on which an image is formed is sent to the post-process device 22.

The control unit 71 may include a post-processing control section 77. The post-processing control section 77 causes the post-process device 22 to perform the post-processing. Specifically, the post-processing control section 77 causes the post-process device 22 to perform at least one of the alignment processes, the staple process, the punch processing, and the shift process.

The control unit 71 may include a center folding control section 78. The center folding control section 78 causes the center folding device 23 to perform the center folding process. The center folding control section 78 may cause the center folding device 23 to perform the saddle stitching process.

The control unit 71 may include a large-capacity sheet feed control section 79. The large-capacity sheet feed control section 79 controls the large capacity sheet feeding device 24 to supply the medium 99 from the large capacity sheet feeding device 24 to the medium transport section 16.

The control unit 71 may include a reading control section 80. The reading control section 80 controls the image reading device 25 to read the document as an image. The reading control section 80 acquires read data from the image reading device 25.

The control unit 71 may include a network communication section 81. The network communication section 81 includes communication hardware according to a predetermined communication standard. The network communication section 81 communicates with an external device via a communication network.

The control unit 71 may include a network blocking section 82. The network blocking section 82 controls opening and closing of the network port switch 34.

The control unit 71 may include a FAX communication section 83. The FAX communication section 83 includes communication hardware for performing facsimile communication through a public line. The FAX communication section 83 transmits and receives the read data to and from another facsimile device via a public line.

The control unit 71 may include a FAX blocking section 84. The FAX blocking section 84 controls opening and closing of the FAX port switch 44.

The control unit 71 may include a power determination section 85. The power determination section 85 determines, based on the power supply information 65, whether or not the electric device can be operated. The power determination section 85 determines, based on the power supply information 65, whether or not each electric device can be operated by the power supply 52. Specifically, the power determination section 85 determines whether or not each of the electric devices such as the print head 15, the medium transport section 16, the intermediate device 21, the post-process device 22, the center folding device 23, the large capacity sheet feeding device 24, the image reading device 25, the network port 31, and the FAX port 41 can be operated by the power supply 52.

The control unit 71 includes a printable sheet number calculation section 86. The printable sheet number calculation section 86 calculates, based on the power supply information 65, the number of sheets of the medium 99 on which printing can be performed by the power supply 52.

### Print control

The control section 60 performs print control. The print control is control performed when the image forming system 10 is operated by the power supply 52. As an example, a case where printing is performed on the medium 99 by the copy function will be described. The print control may be performed when printing is performed on the medium 99 by the printing function. It is assumed that the print mode is set to a default print mode.

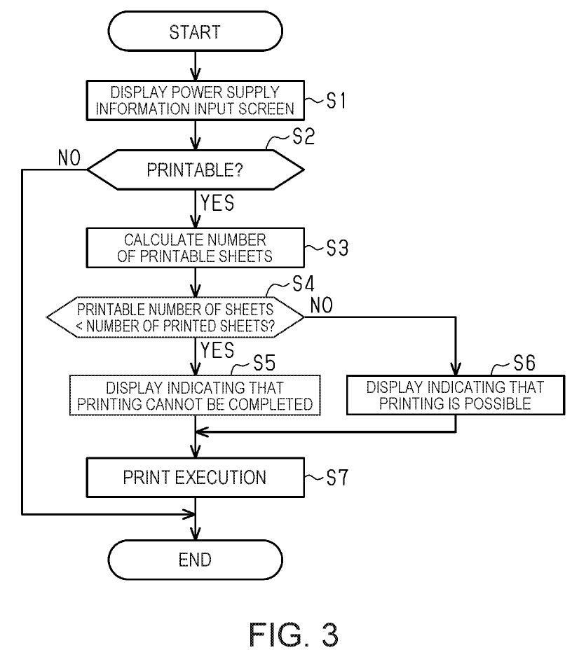

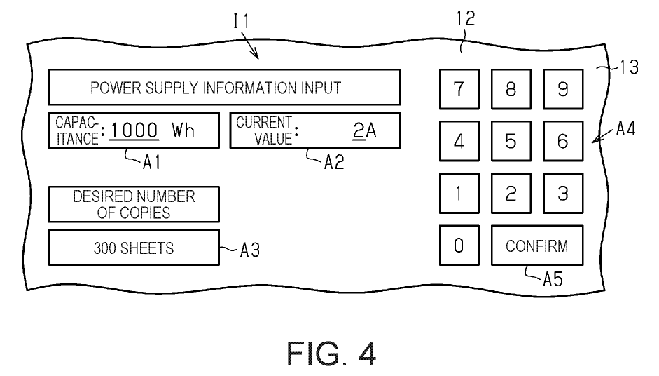

As illustrated in FIGS. 3 and 4, in step S1, the control section 60 causes the display section 12 to display a power source information input screen I1. The power source information input screen I1 is displayed on the display section 12, for example, by the user operating the input section 13.

The power source information input screen I1 includes, for example, a capacitance input section A1 and a current input section A2.

The capacitance input section A1 is a location for inputting the capacitance of the power supply 52. The current input section A2 is a location for inputting the maximum output current of the power supply 52.

The power source information input screen I1 includes a print sheet number input section A3. The print sheet number input section A3 is a section for inputting the print sheet number desired by the user. In the present embodiment, the print sheet number desired by the user to be printed is the copy number desired by the user.

The power source information input screen I1 includes a numerical value inputting section A4 and a permitting section A5. The numerical value inputting section A4 is a portion for inputting numerical values to the capacitance input section A1, the current input section A2, and the print sheet number input section A3. The permitting section A5 is a section for permitting execution of printing.

The user selects a desired one of the capacitance input section A1, the current input section A2, and the print sheet number input section A3, and then operates the numerical value inputting section A4 to input a numerical value. The display device 56 of the power supply 52 displays the charging rate of the power supply 52. The user inputs a value obtained by multiplying the rated capacity of the power supply 52 by the charging rate to the capacitance input section A1. The capacitance input section A1 may include a rated capacity input section and a charging rate input section. In this case, the user may input the rated capacity of the power supply 52 to the rated capacity input section and input the charging rate of the power supply 52 to the charging rate input section. In this case, the capacitance of the power supply 52 is calculated by the control section 60. The specifications of the power supply 52 such as the rated capacity of the power supply 52 and the maximum output current of the power supply 52, for example, can be grasped by checking the specification sheet of the power supply 52 or the label of the power supply 52. When the user inputs numerical values to the capacitance input section A1, the current input section A2, and the print sheet number input section A3, the control section 60 proceeds to step S2. In the example illustrated in FIG. 4, the capacitance of the power supply 52 is 1000 (Wh), the maximum output current is 2 (A), and the desired print sheet number is 300. The numerical values inputted to the capacitance input section A1 and the current input section A2 are stored in the memory 61 as the power supply information 65.

In step S2, the control section 60 determines whether or not printing can be performed from the power supply information 65 input on the power source information input screen I1. For example, when the capacitance of the power supply 52 is smaller than the power value required for one process of the medium transport section 16 or the print head 15, printing cannot be performed. When the maximum output current of the power supply 52 is smaller than the current value required for one process of the medium transport section 16 or the print head 15, printing cannot be performed. In this manner, there are cases where the medium transport section 16 or the print head 15 necessary for performing printing cannot be operated depending on the power supply 52. The control section 60 determines whether or not printing can be performed by referring to the power table 63 and the current table 64. When the determination result of step S2 is positive, that is, when printing can be performed, the control section 60 proceeds to step S3. When the determination result of step S2 is negative, that is, when printing cannot be performed, the control section 60 ends the print control. When the determination result of step S2 is negative, the control section 60 may display, on the display section 12, that printing is impossible. By performing the determination of the step S2, the control section 60 functions as the power determination section 85.

In step S3, the control section 60 calculates the printable number of sheets. The control section 60 calculates the printable number of sheets from the capacitance of the power supply 52 inputted on the power source information input screen I1. The control section 60 calculates a power value required for the operation of the electric device necessary for outputting a single sheet of the medium 99. The power value required to output one sheet of the medium 99 is the sum of the power consumed, during output of one sheet of the medium 99, by the print head 15, the medium transport section 16, the intermediate device 21, the post-process device 22, the center folding device 23, the large capacity sheet feeding device 24, the image reading device 25, the network port 31, and the FAX port 41. When the center folding process, the saddle stitching process, and the post-processing are performed, output of the medium 99 means discharge from the image forming system 10 of the medium 99 after these processes are finished. When the center folding process, the saddle stitching process, and the post-processing are not performed, output of the medium 99 means discharge from the image forming system 10 of the medium 99 on which an image is formed.

The control section 60 refers to the power table 63 to grasp the power consumed by each electric device. The control section 60 refers to the power table 63 to grasp the power consumed by the print head 15, the medium transport section 16, the intermediate device 21, the post-process device 22, the center folding device 23, the large capacity sheet feeding device 24, the image reading device 25, the network port 31, and the FAX port 41. In the present embodiment, the control section 60 may refer to the power table 63 to grasp the power value corresponding to the print mode set by default. When there is an electric device that is not used, the power value required to output one sheet of the medium 99 is calculated by excluding the power value required for the operation of that electric device.

The control section 60 calculates how many sheets of the medium 99 can be output from the power value required to output one sheet of the medium 99 and the capacitance of the power supply 52. Then, the control section 60 sets the number of sheets of the medium 99 that can be output as the printable number of sheets. By performing the process of step S3, the control section 60 functions as the printable sheet number calculation section 86. When the process of step S3 is completed, the control section 60 proceeds to step S4.

In step S4, the control section 60 determines whether or not the printable number of sheets is smaller than the print sheet number input by the user. When the determination result of step S4 is positive, the control section 60 proceeds to step S5. When the determination result of step S4 is negative, the control section 60 proceeds to step S6.

In step S5, the control section 60 causes the display section 12 to display information indicating that printing cannot be completed. The information indicating that the printing cannot be completed may be any information as long as the user can grasp that printing cannot be completed. For example, the control section 60 may cause the display section 12 to display a text indicating that printing cannot be completed.

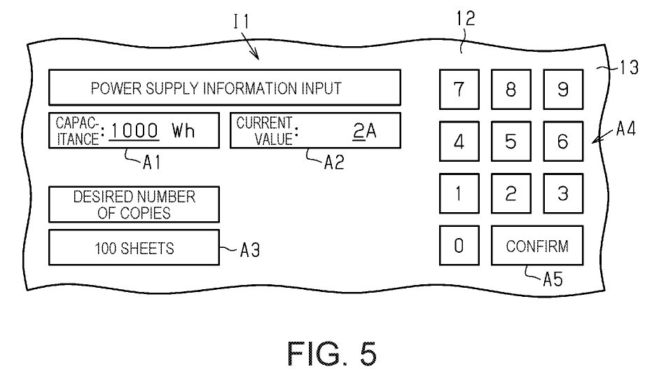

As illustrated in FIG. 5, in one example, the printable number of sheets is displayed in the print sheet number input section A3 as the information indicating that the printing cannot be completed. If the printable number of sheets is calculated as 100 sheets in step S3, 100 sheets is displayed as the printable number of sheets in the print sheet number input section A3. The user can grasp that printing cannot be completed by displaying that the printable number of sheets is smaller than the print sheet number input by the user. When the user operates the permitting section A5, the control section 60 proceeds to step S7. The permitting section A5 is operated when the user allows execution of printing with the printable number of sheets.

In step S6, the control section 60 causes the display section 12 to display information indicating that printing is possible. Information indicating that printing is possible may be any information as long as the user can grasp that printing can be completed. For example, the control section 60 may cause the display section 12 to display a text indicating that printing can be completed.

As illustrated in FIG. 4, in one example, the print sheet number that is input by the user is displayed in a print sheet number input section A3. The user can grasp that printing is possible because the print sheet number input by the user is displayed in the print sheet number input section A3. When the user operates the permitting section A5, the control section 60 proceeds to step S7.

In step S7, the control section 60 executes printing. When printing is completed, the control section 60 ends the print control.

### Update control

The control section 60 may perform an update control when the power supply information 65 is input from the power source information input screen I1. The update control is control for updating the printable number of sheets according to the number of sheets that have been printed. The update control may be control for updating the printable number of sheets in accordance with the power consumption of the power supply 52 with the lapse of time in addition to the number of sheets that have been printed. The power consumption of the power supply 52 over time includes at least one of self-discharge of the power supply 52 and standby power of the image forming system 10.

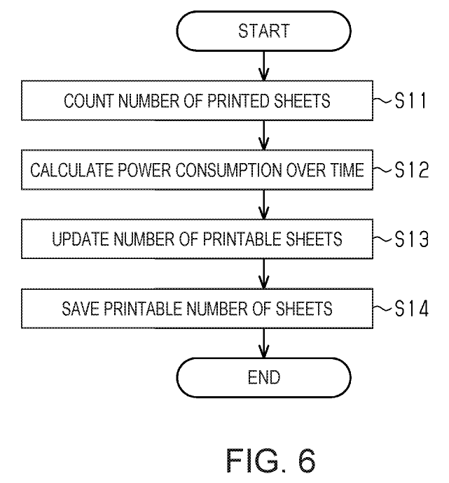

As illustrated in FIG. 6, in step S11, the control section 60 counts the number of sheets printed after the power supply information 65 is input. When the process of step S11 is completed, the control section 60 proceeds to step S12.

In step S12, the control section 60 calculates the power consumption of the power supply 52 accompanying the lapse of time. In one example, the power consumed by the power supply 52 per unit time is calculated in advance. The control section 60 calculates the power consumption of the power supply 52 accompanying the lapse of time based on the elapsed time from the input of the power supply information 65 and the power consumed by the power supply 52 per unit time. When the process of step S12 is completed, the control section 60 proceeds to step S13.

In step S13, the control section 60 updates the printable number of sheets. The control section 60 may update the printable number of sheets by subtracting the number of sheets counted in step S11 from the printable number of sheets.

When the printable number of sheets is updated according to the power consumption of the power supply 52 accompanying the lapse of time, the control section 60 converts the power consumption calculated in step S12 into a print equivalence number. The print equivalence number is a numerical value indicating how many sheets of printing the power consumption of the power supply 52 accompanying the lapse of time corresponds to. That is, the print equivalence number is the number of sheets of the medium 99 that can be printed with the power consumption of the power supply 52 over time. The print equivalence number can be calculated based on the power consumption calculated in step S12 and the power value required to output one sheet of the medium 99.

The control section 60 may update the printable number of sheets by subtracting the number of sheets counted in the step S11 and the print equivalence number from the printable number of sheets. When the process of step S13 is completed, the control section 60 proceeds to step S14.

In step S14, the control section 60 stores the printable number of sheets updated in step S13 in the memory 61. When the process of step S14 is completed, the control section 60 ends the update control.

The update control may be performed at a predetermined control cycle or may be performed each time the print control is executed.

When performing the update control, the control section 60 determines whether or not the printable number of sheets is stored in the memory 61 at the time of performing the print control. When the printable number of sheets is stored in the memory 61, the control section 60 may perform print control using the printable number of sheets stored in the memory 61.

The printable number of sheets stored in the memory 61 is erased when new power supply information 65 is input.

### Operation of first embodiment

When the image forming system 10 is operated by the power supplied from the power supply 52, the user inputs the power supply information 65 by operating the input section 13. The power supply information 65 includes at least information indicating the capacitance of the power supply 52. The control section 60 can calculate the printable number of sheets from the information indicating the capacitance of the power supply 52.

### Effects of first embodiment

(1-1) When the printable number of sheets is smaller than the print sheet number input by the user, the control section 60 causes the display section 12 to display information indicating that printing cannot be completed. When the printable number of sheets is the same as the print sheet number input by the user or when the printable number of sheets is larger than the print sheet number input by the user, the control section 60 causes the display section 12 to display information indicating that printing is possible. Therefore, when the user operates the image forming system 10 by the power supply 52, the user can grasp whether or not the print sheet number input by the user can be printed. Therefore, it is possible to suppress the power supply from the power supply 52 from being interrupted in the middle of printing.

(1-2) When the printable number of sheets is smaller than the print sheet number, the control section 60 displays the printable number of sheets on the display section 12. This enables the user to grasp the printable number of sheets when the input print sheet number cannot be printed.

(1-3) The control section 60 displays the printable number of sheets and the permitting section A5 on the display section 12. When the user operates the permitting section A5, printing is executed with the printable number of sheets. Therefore, the user can perform printing on the medium 99 within a range in which printing can be performed by the power supply 52.

(1-4) The image forming system 10 includes the image reading device 25. Therefore, the image read by the image reading device 25 can be printed on the medium 99.

(1-5) The control section 60 updates the printable number of sheets according to the number of sheets of the medium 99 on which printing is executed. When printing is executed, the capacitance of the power supply 52 decreases due to the power of the power supply 52 being consumed. Therefore, when the printable number of sheets is calculated from the capacitance of the power supply 52, it is necessary to input the power supply information 65 every time the image forming system 10 is used. In contrast, by updating the printable number of sheets according to the number of sheets of the medium 99 on which printing was executed, the control section 60 can recognize the printable number of sheets even when new power supply information 65 is not input.

### Second Embodiment

A second embodiment of the image forming system will be described. The image forming system of the second embodiment is different from that of the first embodiment in the print control. The second embodiment is different from the first embodiment in that the default print mode is not set. In the second embodiment, a print mode is selected by a user from a plurality of print modes. Hereinafter, the print control of the second embodiment will be described.

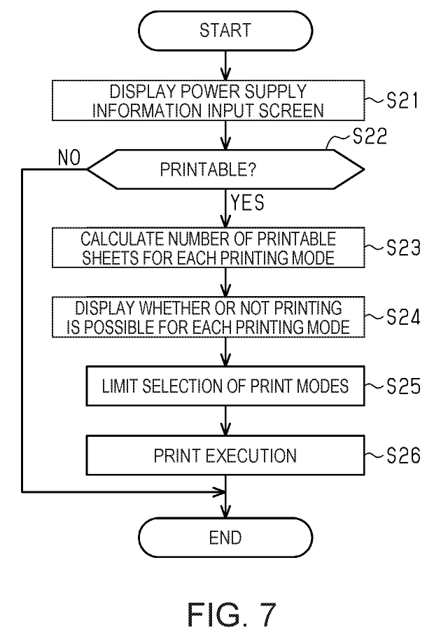

As illustrated in FIG. 7, in step S21, the control section 60 causes the display section 12 to display a power source information input screen I1. The power source information input screen I11 displayed in the step S21 is, for example, the same as that in the first embodiment. When the process of step S21 is completed, the control section 60 proceeds to step S22.

In step S22, the control section 60 determines whether or not printing can be performed. The determination of the step S22 is the same determination as the step S2. When the determination result of step S22 is negative, the control section 60 ends the print control. When the determination result of step S22 is positive, the control section 60 proceeds to step S23.

In step S23, the control section 60 calculates the printable number of sheets for each of the plurality of print modes. The control section 60 calculates the power value required to output one sheet of the medium 99 for each print mode by referring to the power table 63. The control section 60 calculates how many sheets of the medium 99 can be output for each print mode from the power value required to output one sheet of the medium 99 and the capacitance of the power supply 52. Then, the control section 60 sets the number of sheets of the medium 99 that can be output as the printable number of sheets. The control section 60 calculates the printable number of sheets for each of all the print modes that can be set in the image forming system 10. When the process of step S23 is completed, the control section 60 proceeds to step S24.

In step S24, the control section 60 displays whether or not printing is possible for each print mode.

The control section 60 determines whether or not the printable number of sheets is smaller than the print sheet number input by the user for each print mode. Then, the control section 60 causes the display section 12 to display information indicating that printing cannot be completed for a print mode in which the printable number of sheets is smaller than the print sheet number input by the user. When the printable number of sheets is the same as the print sheet number input by the user in the print mode, the control section 60 causes the display section 12 to display information indicating that printing is possible. The control section 60 also displays information indicating that printing is possible on the display section 12 when the print mode in which the printable number of sheets is larger than the print sheet number input by the user.

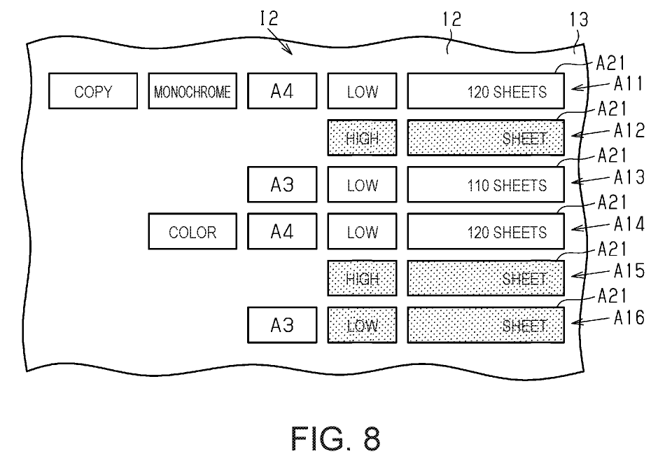

FIG. 8 illustrates an example of a display screen I2 displayed on the display section 12. The display screen I2 may be displayed on the display section 12 simultaneously with the power source information input screen I1. In FIG. 8, six print modes are displayed on the display section 12. Monochrome printing, with the size of the medium 99 in A4 size, and at low resolution, is referred to as a first print mode. Monochrome printing, with the size of the medium 99 in A4 size, and with high resolution, is referred to as a second print mode. Monochrome printing, with the size of the medium 99 in A3 size, and at a low resolution, is referred to as a third print mode. Color printing, with the size of the medium 99 in A4 size, and with low resolution, is defined as a fourth print mode. Color printing, with the size of the medium 99 in A4 size, and with high resolution, is set as a fifth print mode. Color printing, with the size of the medium 99 in A3 size, and with low resolution, is defined as a sixth print mode.

The display screen I2 includes a first mode display section A11 on which a display related to the first print mode is performed, a second mode display section A12 on which a display related to the second print mode is performed, and a third mode display section A13 on which a display related to the third print mode is performed. The display screen I2 includes a fourth mode display section A14 on which a display related to the fourth print mode is performed, a fifth mode display section A15 on which a display related to the fifth print mode is performed, and a sixth mode display section A16 on which a display related to the sixth print mode is performed.

The contents of the print modes corresponding to the mode display sections A11 to A16 are displayed on the mode display sections A11 to A16. For example, in the case of the first mode display section A11, the content of the first print mode corresponding to the first mode display section A11, that is, monochrome printing, the size of the medium 99 in A4 size, and printing at low resolution, is displayed.

Each of the mode display section A11 to A16 includes a printable sheet number display section A21. The printable sheet number display section A21 is a portion where the printable number of sheets in each print mode is displayed. In a print mode in which the printable number of sheets is smaller than the print sheet number input by the user, no numerical value is displayed in the printable sheet number display section A21. For a print mode in which the printable number of sheets is smaller than the print sheet number input by the user, the corresponding mode display sections A11 to A16 are grayed out or erased from the display screen I2.

In a print mode in which the printable number of sheets is equal to the print sheet number input by the user or the printable number of sheets is larger than the print sheet number input by the user, the printable number of sheets is displayed on the printable sheet number display section A21.

In the display screen I2 illustrated in FIG. 8, the printable number of sheets displayed on the printable sheet number display section A21 is information indicating that printing is possible. Information indicating that printing cannot be completed is represented by no numerical value being displayed in the printable sheet number display section A21, the section being shown in grey by being grayed out, or the mode display sections A11 to A16 being deleted from the display screen I2.

In this manner, by the control section 60 displaying the display screen I2 on the display section 12, the print modes are presented in which the print sheet number desired by the user can be printed. When the process of step S24 is completed, the control section 60 proceeds to step S25.

In step S25, the control section 60 restricts the selection of the print mode. When the print mode in which the print sheet number desired by the user can be printed is presented, the user selects the print mode. In the example illustrated in FIG. 8, the user can select the print mode corresponding to the mode display sections A11 to A16 by operating any one of the mode display sections A11 to A16. For example, by operating the first mode display section A11, the first print mode corresponding to the first mode display section A11 can be selected.

For a print mode in which the printable number of sheets is smaller than the print sheet number input by the user, the control section 60 restricts selection of the print mode even when the corresponding mode display sections A11 to A16 are operated. In the example illustrated in FIG. 8, the control section 60 will not execute printing in the second print mode, the fifth print mode, and the sixth print mode, even if the second mode display section A12, the fifth mode display section A15, and the sixth mode display section A16 were to be operated. When the print mode is selected by the user, the control section 60 proceeds to step S26.

In step S26, the control section 60 executes printing in the print mode selected by the user. When printing is completed, the control section 60 ends the print control. It should be noted that, as in the first embodiment, the printable number of sheets smaller than the print sheet number input by the user may be displayed on the printable sheet number display section A21 in step S24 as the information indicating that printing cannot be completed. For example, when the printable number of sheets is 90 sheets in the second print mode, which is monochrome printing, with size of the medium 99 being A4 size, and printing being performed at high resolution, then 90 sheets may be displayed in the printable sheet number display section A21 of the second print mode. The user can grasp that printing cannot be completed by displaying that the printable number of sheets is smaller than the print sheet number input by the user. In this case, the process of step S25 may be omitted. In this case, when the user selects the second print mode and operates the permitting section A5, the control section 60 proceeds to step S26. The permitting section A5 is operated when the user allows execution of printing with the printable number of sheets.

### Effects of second embodiment

According to the second embodiment, the following effects can be obtained in addition to the effects of the first embodiment.

(2-1) The control section 60 calculates the printable number of sheets for each of the plurality of print modes. This enables the user to grasp the printable number of sheets for each print mode. The user can select a print mode for executing printing from the presented print mode.

(2-2) The control section 60 restricts selection of the print mode in which the printable number of sheets is smaller than the print sheet number input by the user. This can suppress selection of print modes that cannot complete printing.

### Third Embodiment

A third embodiment of the image forming system will be described. The image forming system of the third embodiment is different from that of the first embodiment in the print control. Hereinafter, the print control of the third embodiment will be described.

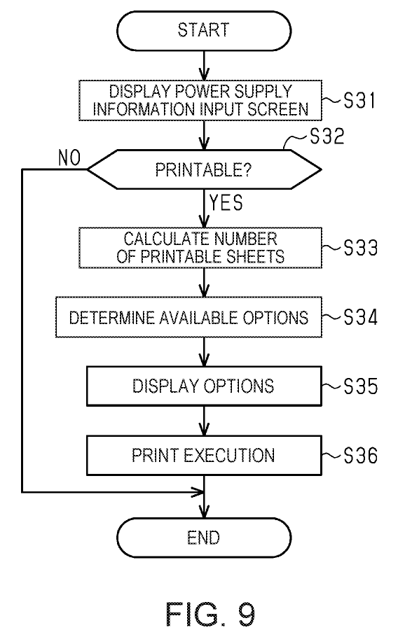

As illustrated in FIG. 9, in step S31, the control section 60 causes the power source information input screen I1 to be displayed on the display section 12. The power source information input screen I1 displayed in the step S31 is, for example, the same as that in the first embodiment. When the process of step S31 is completed, the control section 60 proceeds to step S32.

In step S32, the control section 60 determines whether or not printing can be performed. The determination of the step S32 is the same determination as the step S2. When the determination result of step S32 is negative, the control section 60 ends the print control. When the determination result of step S32 is positive, the control section 60 proceeds to step S33.

In step S33, the control section 60 calculates the printable number of sheets. In the present embodiment, the control section 60 calculates the printable number of sheets in the case of an option function being enabled and the printable number of sheets in the case of the option function being disabled.

The options are an additional cassette 14B, a floor finisher, an inner finisher, an additional FAX port 43, an additional network port 33, and a large capacity sheet feeding device 24. The control section 60 calculates, by referring to the power table 63, the printable number of sheets when each function of the options is enabled and the printable number of sheets when the functions are disabled. Therefore, the control section 60 calculates, based on the power value required for the operation of the post-process device 22, the printable number of sheets in a case where the function of the post-process device 22 is enabled and the printable number of sheets when the function of the post-process device 22 is disabled. The control section 60 calculates, based on the power value required for the operation of the large capacity sheet feeding device 24, the printable number of sheets in a case where the function of the large capacity sheet feeding device 24 is enabled and the printable number of sheets when the function of the large capacity sheet feeding device 24 is disabled.

The control section 60 calculates a power value required to output one sheet of the medium 99 when each function of the options is enabled by referring to the power table 63. The control section 60 calculates how many sheets of the medium 99 can be output from the power value required to output one sheet of the medium 99 when each function of the option is enabled and the capacitance of the power supply 52. The control section 60 calculates, by referring to the power table 63, a power value required to output one sheet of the medium 99 when the option function is disabled. The control section 60 calculates how many sheets of the medium 99 can be output from the power value required to output one sheet of the medium 99 in the case of an option function being disabled and from the capacitance of the power supply 52. The control section 60 sets the number of the medium 99 that can be output as the printable number of sheets. When the process of step S33 is completed, the control section 60 proceeds to step S34.

In step S34, the control section 60 determines which option can be enabled. Whether or not the option can be enabled is determined based on the power table 63 and the current table 64. In a case where the printable number of sheets does not become smaller than the print sheet number input by the user even if the function of the option is enabled, the option can be enabled. In a case where the printable number of sheets becomes smaller than the print sheet number input by the user by enabling the function of the option, the option cannot be enabled.

If the current required to output a single sheet of the medium 99 does not exceed the maximum output current even if the function of the option is enabled, the option can be enabled. In a case where the current required to output one sheet of the medium 99 by enabling the function of the option exceeds the maximum output current, the option cannot be enabled.

In this manner, the control section 60 determines whether or not an option can be enabled based on the power table 63 and the current table 64. By performing the process of step S34, the control section 60 functions as the power determination section 85. When the process of step S34 is completed, the control section 60 proceeds to step S35.

In step S35, the control section 60 presents, to the user, the options that can be enabled.

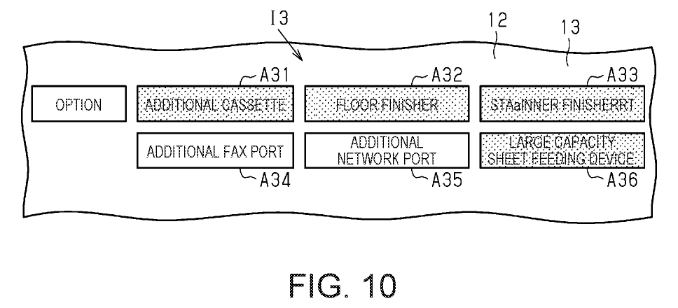

As illustrated in FIG. 10, the control section 60 displays an option selection screen I3 on the display section 12 to present options that can be enabled. The option selection screen I3 may be displayed on the display section 12 simultaneously with the power source information input screen I1. The option selection screen I3 includes selection sections A31 to A36 corresponding to the options. In the example illustrated in FIG. 10, the option selection screen I3 includes a first selection section A31 corresponding to the additional cassette 14B, a second selection section A32 corresponding to the floor finisher, and a third selection section A33 corresponding to the inner finisher. The option selection screen I3 includes a fourth selection section A34 corresponding to the additional FAX port 43, a fifth selection section A35 corresponding to the additional network port 33, and a sixth selection section A36 corresponding to the large capacity sheet feeding device 24.

The control section 60 presents options that can be enabled by, for example, making the display modes of the selection sections A31 to A36 different from each other. For example, the control section 60 grays out the selection sections A31 to A36 corresponding to the options that cannot be enabled. In the example illustrated in FIG. 10, the functions of the additional cassette 14B corresponding to the first selection section A31, the floor finisher corresponding to the second selection section A32, the inner finisher corresponding to the third selection section A33, and the large capacity sheet feeding device 24 corresponding to the sixth selection section A36 cannot be enabled. The functions of the additional FAX port 43 corresponding to the fourth selection section A34 and the additional network port 33 corresponding to the fifth selection section A35 can be enabled. The control section 60 may delete, from the display section 12, the selection sections A31 to A36 corresponding to the options that cannot be enabled.

The user can enable options by operating the selection portions A31 to A36. The options that can be enabled may decrease according to options selected by the user. In the example illustrated in FIG. 10, there is a case where the printable number of sheets becomes smaller than the print sheet number or the current exceeds the maximum output current by enabling the functions of both the additional FAX port 43 and the additional network port 33. In this case, when one of the additional FAX port 43 and the additional network port 33 is selected, the selection selections A31 to A36 corresponding to the other may be grayed out.

The image forming system 10 may not include both the floor finisher and the inner finisher. Therefore, when one of the floor finishers and the inner finisher is selected, the selection sections A31 to A36 corresponding to the other may be grayed out.

The control section 60 may open the FAX port switch 44 when the function of the additional FAX port 43 is disabled by the option selection screen I3. When the function of the additional network port 33 is disabled by the option selection screen I3, the control section 60 may open the network port switch 34. When the option to be enabled is selected by the user, the control section 60 proceeds to step S36.

In step S36, the control section 60 enables the option selected in step S35 and executes printing. When printing is completed, the control section 60 ends the print control.

### Effects of third embodiment

According to the third embodiment, the following effects can be obtained in addition to the effects of the first embodiment.

(3-1) The control section 60 calculates the printable number of sheets in a case where the function of the post-process device 22 is enabled and the printable number of sheets when the function of the post-process device 22 is disabled. Therefore, the control section 60 can determine whether the printable number of sheets is smaller than the print sheet number input by the user when the post-process device 22 is operated. When the post-process device 22 is operated, in a case where the printable number of sheets is smaller than the print sheet number input by the user, the control section 60 does not present the post-process device 22 as an option that can be enabled. Therefore, the user can easily select an option to be enabled.

(3-1) The control section 60 calculates the printable number of sheets when the function of the large capacity sheet feeding device 24 is enabled and the printable number of sheets in a case where the function of the large capacity sheet feeding device 24 is disabled. Therefore, the control section 60 can determine whether the printable number of sheets is smaller than the print sheet number input by the user when the large capacity sheet feeding device 24 is operated. When the large capacity sheet feeding device 24 is operated, the control section 60 does not present the large capacity sheet feeding device 24 as an option that can be enabled in a case where the print sheet number is smaller than the printable number of sheets input by the user. Therefore, the user can easily select an option to be enabled.

### Modifications

The embodiments may be modified as follows: The embodiments and the following modifications can be implemented in combination with each other within a range where no technical contradiction occurs.

In the third embodiment, the user may be able to select a print mode. Then, the control section 60 calculates the printable number of sheets in the print mode selected by the user for the case of the option function being enabled and the printable number of sheets for the case of the option function being disabled. The control section 60 may restrict, based on the print mode selected by the user, the function of the post-process device 22. For example, if the printable number of sheets becomes smaller than the print sheet number input by the user because the function of the post-process device 22 is enabled, the control section 60 may be configured not to enable the function of the post-process device 22.

When the power value required for one process is associated with each post-process that can be performed by the post-process device 22 in the power table 63, the printable number of sheets when the function is enabled may be calculated for each post-process. In the example of the embodiment, the printable number of sheets in a case where the function is enabled is calculated for each of the alignment process, the staple process, the punch process, and the shift process. It may be possible to select whether to enable or disable the function for each of the alignment process, the staple process, the punch process, and the shift process. At this time, when enabling the post-process function causes the printable number of sheets to become smaller than the print sheet number input by the user, the control section 60 may be configured not to enable the function of the post-processing.

According to this configuration, when the post-process device 22 cannot be operated in the print mode selected by the user, it is possible to suppress the function of the post-process device 22 from being enabled.

In the third embodiment, the option that enables or disables the function may include the center folding device 23. In this case, the processing section includes at least one of the post-process device 22 and the center folding device 23.

In each embodiment, the image forming system 10 may include a wireless communication device wirelessly connected to a communication network, instead of or in addition to the network port 31.

In each embodiment, the image forming system 10 may include at least the image forming device 11.

In each embodiment, the power supply information 65 may be acquired by communication between the control section 60 and the power supply 52. For example, the image forming system 10 and the power supply 52 may include a communication section configured to communicating with each other, and the control section 60 may acquire the power supply information 65 from the battery management system 55 through communication by the communication section. The communication may be wired communication or wireless communication.

### Definitions

As used herein, the expression "at least one" means "one or more" of the desired options. As an example, the expression "at least one" used in the present specification means "only one option" or "both of two options" when the number of options is two. As another example, the expression "at least one" used in the present specification means "only one option" or "a combination of two or more arbitrary options" when the number of options is three or more.

### Technical ideas

Hereinafter, technical ideas and effects thereof grasped from the above-described embodiment and modifications will be described.

(A) An image forming system that operates with power supplied from power supply, the image forming system includes a print head configured to print on a medium; a medium transport section that transports the medium toward the print head; a display section configured to display information related to the printing; an input section that receives input from a user; and

a control section that controls the display section, wherein the control section calculates a printable number of sheets of the medium that are printable by the print head based on power supply information, which is information of the power supply and which includes at least information indicating capacitance of the power supply, displays, on the display section, information indicating that printing cannot be completed when the printable number of sheets is smaller than a print sheet number input by the user, and displays, on the display section, information indicating that printing is possible when the printable number of sheets is the same as the print sheet number or when the printable number of sheets is larger than the print sheet number.

According to this configuration, the control section can calculate the printable number of sheets. When the user operates the image forming system by the power supply, the user can grasp whether the print sheet number input by the user is possible. Therefore, it is possible to suppress interruption of the power supply from the power source during printing.

(B) The image forming system according to (A), wherein

the control section is configured to display the printable number of sheets on the display section when the printable number of sheets is smaller than the print sheet number.

According to this configuration, the user can grasp the printable number of sheets when the printing of the print sheet number input by the user cannot be performed.

(C) The image forming system according to (A) or (B), wherein the control section causes display, on the display section, of a permission section for permitting the user to execute printing with the printable number of sheets.

According to this configuration, the user can perform printing on the medium within a range where printing is possible based on the power supply.

(D) The image forming system according to any one of (A) to (C), further comprising: a plurality of print modes, wherein the control section calculates the printable number of sheets for each of the plurality of print modes.

According to this configuration, the user can grasp the printable number of sheets for each print mode. The user can select a print mode for executing printing from the presented print mode.

(E) The image forming system according to (D), wherein

among the plurality of print modes, the control section restricts selection of a print mode in which the printable number of sheets is smaller than the print sheet number.

According to this configuration, it is possible to suppress the selection of the print mode in which the printing cannot be completed.

(F) The image forming system according to any one of (A) to (E), further including a processing section that performs processing on the medium on which printing was performed, wherein

the control section is configured to calculate, based on a power value required for an operation of the processing section, the printable number of sheets for when a function of the processing section is enabled and the printable number of sheets for when the function of the processing section is disabled.

According to this configuration, the control section can determine whether the printable number of sheets is smaller than the print sheet number input by the user when the function of the processing section is enabled.

(G) The image forming system according to (F), wherein

the control section limits a function of the processing section based on a print mode selected by the user.

According to this configuration, when the processing section cannot be operated in the print mode selected by the user, it is possible to suppress the function of the processing section from being enabled.

(H) The image forming system according to any one of (A) to (G), further including a medium supply device that supplies the medium to the medium transport section, wherein the control section calculates, based on a power value required to operation the medium supply device, the printable number of sheets for when a function of the medium supply device is enabled and the printable number of sheets for when the function of the medium supply device is disabled.

According to this configuration, the control section can determine whether the printable number of sheets is smaller than the print sheet number input by the user when the medium supply device is operated.

(I) The image forming system according to any one of (A) to (H), further including an image reading device that reads a document as an image, wherein the image reading device has a copy function of printing an image read by the image reading device on the medium.

According to this configuration, it is possible to print an image read by the image reading device on a medium.

What is claimed is:

1. An image forming system that operates by power supplied from a power supply, the image forming system comprising:
a print head configured to print on a medium;
a medium transport section that transports the medium toward the print head;
a display section configured to display information related to printing;
an input section that receives input from a user; and
a control section that controls the display section, wherein
the control section
calculates a printable number of sheets of the medium that are printable by the print head based on power supply information, which is information of the power supply and which includes at least information indicating capacitance of the power supply,
displays, on the display section, information indicating that printing cannot be completed when the printable number of sheets is smaller than a print sheet number input by the user, and
displays, on the display section, information indicating that printing is possible when the printable number of sheets is the same as the print sheet number or when the printable number of sheets is larger than the print sheet number.

2. The image forming system according to claim 1, wherein
the control section is configured to display the printable number of sheets on the display section when the printable number of sheets is smaller than the print sheet number.

3. The image forming system according to claim 2, wherein
the control section causes display, on the display section, of a permission section for permitting the user to execute printing with the printable number of sheets.

4. The image forming system according to claim 1, further comprising:
a plurality of print modes, wherein
the control section calculates the printable number of sheets for each of the plurality of print modes.

5. The image forming system according to claim 4, wherein
among the plurality of print modes, the control section restricts selection of a print mode in which the printable number of sheets is smaller than the print sheet number.

6. The image forming system according to claim 1, further comprising:
a processing section that performs processing on the medium on which printing was performed, wherein
the control section is configured to calculate, based on a power value required for an operation of the processing section, the printable number of sheets for when a function of the processing section is enabled and the printable number of sheets for when the function of the processing section is disabled.

7. The image forming system according to claim 6, wherein
the control section limits a function of the processing section based on a print mode selected by the user.

8. The image forming system according to claim 1, further comprising:
a medium supply device that supplies the medium to the medium transport section, wherein
the control section calculates, based on a power value required to operation the medium supply device, the printable number of sheets for when a function of the medium supply device is enabled and the printable number of sheets for when the function of the medium supply device is disabled.

9. The image forming system according to claim 1, further comprising:
an image reading device that reads a document as an image, wherein
the image reading device has a copy function of printing an image read by the image reading device on the medium.

10. A control method of an image forming system operated by power supplied from a power supply, the image forming system including
a print head that performs printing on a medium, a display section that is configured to display information related to printing, and an input section that receives input from a user, the control method comprising:
acquiring power supply information including information that indicate a capacitance of the power supply;
calculating, based on the power supply information, a printable number of sheets, which is a number of sheets of the medium on which printing by the print head is possible;
displaying, on the display section information indicating that printing cannot be completed when the printable number of sheets is smaller than the print sheet number input by the user; and
displaying, on the display section, information indicating that printing is possible when the printable number of sheets is the same as the print sheet number or when the printable number of sheets is larger than the print sheet number.
